(19) United States
(12) Patent Application Publication
(10) Pub. No.: US 2012/0106622 A1
(43) Pub. Date: May 3, 2012

(54) Method and Apparatus of Slice Grouping for High Efficiency Video Coding

(75) Inventors: Yu-Wen Huang, Taipei (TW); Ching-Yeh Chen, Taipei (TW); Chih-Ming Fu, Hsinchu (TW); Chih-Wei Hsu, Taipei (TW); Shaw-Min Lei, Hsinchu (TW)

(73) Assignee: MEDIATEK INC., Hsinchu (TW)

(21) Appl. No.: 12/984,727

(22) Filed: Jan. 5, 2011

Related U.S. Application Data
(60) Provisional application No. 61/409,715, filed on Nov. 3, 2010.

(51) Int. Cl. H04N 7/26

(52) U.S. Cl. 375/240.01; 375/E07.026

(57) ABSTRACT

In the H.264/AVC standard, one of the new characteristics is the possibility of dividing an image in regions called slice groups. The use of slice groups provides various possible advantages such as prioritized transmission, error resilient transmission, and etc. The slice groups can be formed by flexible macroblock ordering (FMO), where each picture can be divided into slice groups in different scan patterns of the macroblocks. In the high efficiency video coding (HEVC) under development, a more flexible block structure, called coding unit (CU), is used as the unit to process video data. The picture is first divided into largest CUs (LCUs) and each LCU is adaptively split into smaller CUs using a quadtree until leaf CUs are reached. In the current HEVC development, there is neither slice nor slice group structure being considered. The LCU size used for HEVC is 16 times as large as the macroblock size used in the H.264/AVC standard. Therefore, it is very desirable to develop slice and slice group structure suited for HEVC to offer various benefits of error resilience, parallel processing, reduced line (row) buffer requirement, and etc. Accordingly, slice group types including raster scan type, vertical stripe type, regions of interest type and full flexibility type are developed for HEVC. Furthermore, various syntax elements are incorporated in the sequence header or the picture header to convey information associated with the slice group structure.

### CROSS REFERENCE TO RELATED APPLICATIONS

The present invention claims priority U.S. Provisional Patent Application No. 61/409,715, filed Nov. 3, 2010, entitled “Slice Groups for High Efficiency Video Coding”. The U.S. Provisional Patent Applications is hereby incorporated by reference in its entirety.

### FIELD OF THE INVENTION

The present invention relates to video coding. In particular, the present invention relates to coding techniques associated with slice grouping.

### BACKGROUND

In the H.264/AVC standard, one of the new characteristics is the possibility of dividing an image into regions called slice groups. The use of slice groups provides various possible advantages such as prioritized transmission, error resilient transmission, and etc. The slice groups can be formed by flexible macroblock ordering (FMO), where each picture can be divided into slice groups in different scan patterns of the macroblocks. There are seven FMO map types, referred to as type 0 through Type 6 as defined in the H.26/AVC standard. Type 6 is the most general one and allows full flexibility.

In the high efficiency video coding (HEVC) under development, a more flexible block structure, called coding unit (CU), is used as the unit to process video data. The picture is first divided into largest CUs (LCUs) and each of the LCUs is adaptively split into smaller CUs using a quadtree until leaf CUs are reached. In the current HEVC development, there is neither slice nor slice group structure being considered. The LCU size used for HEVC is 16 times as large as the macroblock size used in the H.264/AVC standard. It is very desirable to develop slice and slice group structure suited for HEVC to offer various benefits of error resilience, parallel processing, reduced line (row) buffer requirement, and etc.

### BRIEF SUMMARY OF THE INVENTION

An apparatus and method for coding of video pictures using slice groups are disclosed. Each of the video pictures is divided into a plurality of LCUs (largest coding units). In one embodiment according to the present invention, the apparatus and method for video coding comprises steps of partitioning each of the video pictures into two or more slice groups according to one or more slice group type, wherein each of two or more slice groups comprises one or more member LCUs of the plurality of LCUs and the one or more member LCUs are configured into one or more consecutive slices. The one or more slice group types include a vertical-stripe type wherein each of two or more slice groups consists of one or more consecutive vertical LCU columns. The apparatus and method for video coding further comprise a step of processing each of two or more slice groups to provide a bitstream corresponding to each of two or more slice groups, wherein the bitstream can be used to recover each of two or more slice groups independently. When the vertical-stripe type is selected, each of two or more slice groups except for a last one of two or more slice groups contains a fixed number of one or more consecutive vertical LCU columns and the last one of two or more slice groups contains less than or equal to the fixed number of one or more consecutive vertical LCU columns. The one or more slice group types also comprises a raster scan type, wherein two or more slice groups are formed by slicing the plurality of LCUs in a raster scan order. The one or more slice group types further comprises an ROI (regions-of-interest) type, wherein each of two or more slice groups except for a last one of two or more slice groups is in a rectangular shape, and the last one of two or more slice groups consists of remains LCUs of the plurality of LCUs. Furthermore, the apparatus and method according to the present invention utilize various syntax elements incorporated in the sequence header or the picture header to convey information associated with the slice group structure.

An apparatus and method for decoding of a video bitstream corresponding to video pictures, wherein each of the video pictures is divided into a plurality of LCUs (largest coding units) and the plurality of LCUs are configured into two or more slice groups are disclosed. In one embodiment according to the present invention, the apparatus and method comprise steps of extracting a number of two or more slice groups from a sequence header or a picture header of the video bitstream, extracting a slice group type from the sequence header or the picture header of the video bitstream and recovering the two or more slice groups according to the slice group type. The slice group type may be a vertical-stripe type, a raster scan type or an ROI type. In each respective slice group type, required information about the slice group structure is extracted and used to recover the two or more slice groups.

### BRIEF DESCRIPTION OF THE DRAWINGS

FIGS. 1A-1F illustrate slice group types 0 through 5 respectively for the H.264/AVC standard.

FIG. 2 illustrates an exemplary coding unit partition based on the quadtree.

FIG. 3 illustrates an example of slice partition where the partition boundaries are aligned with the largest coding unit.

FIG. 4 illustrates an example of slice partition where the slices may include fractional largest coding units.

FIG. 5 illustrates an example of slice groups according to the slice group structure of type 0 for HEVC.

FIG. 6 illustrates an example of slice groups according to the slice group structure of type 1 for HEVC.

FIG. 7 illustrates an example of slice groups according to the slice group structure of type 2 for HEVC.

FIG. 8 illustrates an example of incorporating slice group information in the sequence header for HEVC.

### DETAILED DESCRIPTION OF THE INVENTION

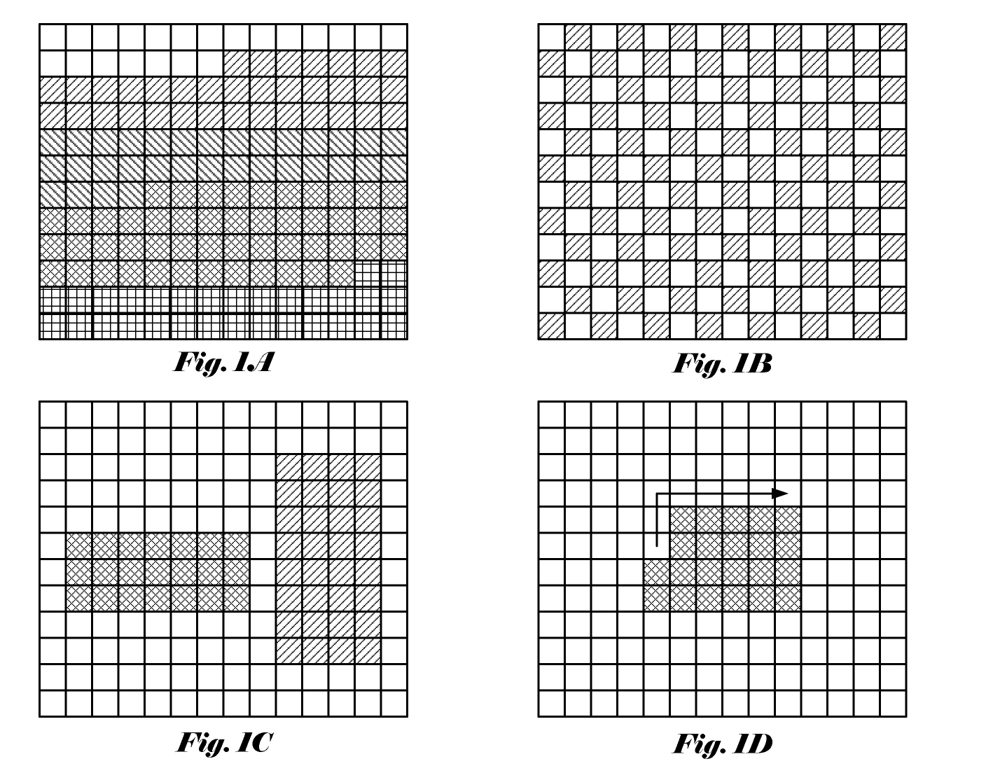

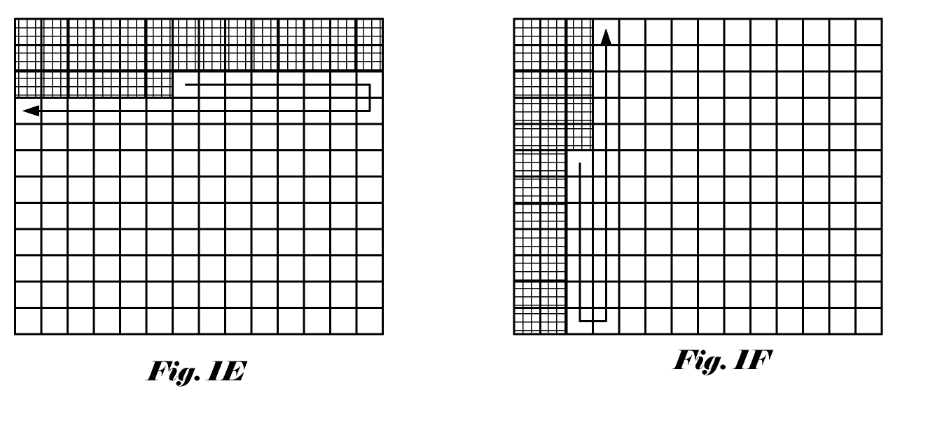

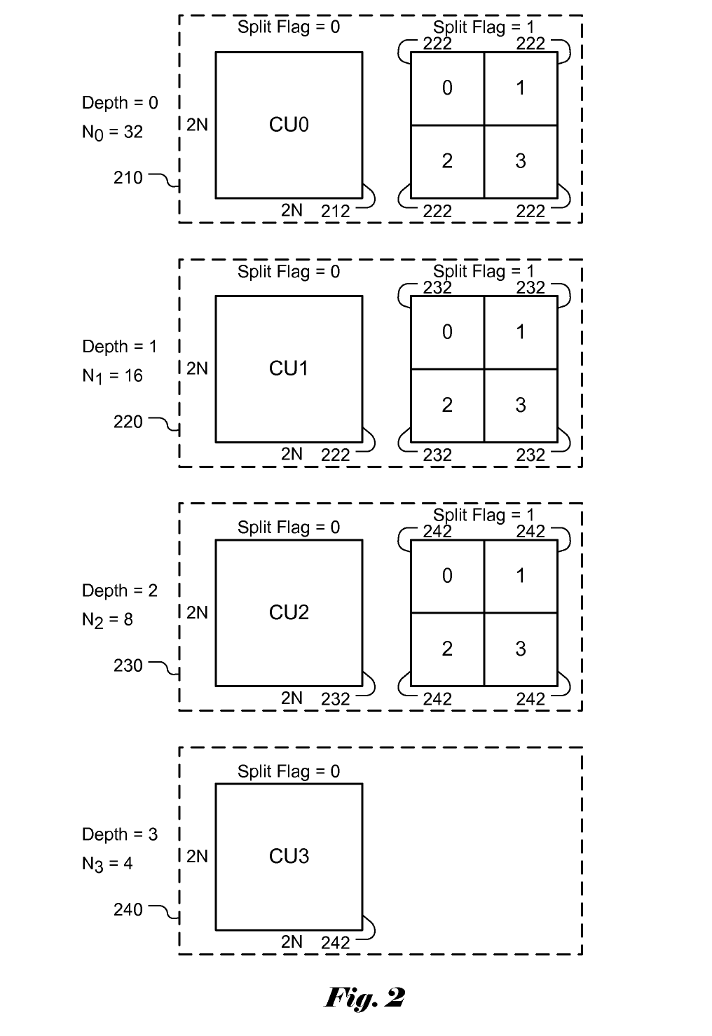

In the H.264/AVC standard, one of the new characteristics is the possibility of dividing an image into regions called slice groups. The use of slice groups provides various potential advantages such as prioritized transmission, error resilient transmission, and etc. For example, in a video conference application, slice groups corresponding to the head and shoulder of a participant can be defined and allocated higher processing/transmission priority. Therefore, good video quality may still be achieved in case of network congestion. Error resilience is another benefit that slice groups can offer. For example, a macroblock and its surrounding macroblocks can be assigned to different slice groups. Usually the slice groups are transmitted independently so that one slice group may be impacted by transmission errors while others may be intact. Therefore if the current block is damaged by transmission errors, its surrounding macroblocks may still be intact. The current macroblock can thus be recovered by exploiting the spatial redundancy from its surrounding macroblocks. The slice groups can be formed by flexible macroblock ordering (FMO), where each picture can be divided into slice groups in different scan patterns through the macroblocks. There are seven FMO map types, referred to as Type 0 through Type 6 as defined in the H.26/AVC standard. Type 6 is the most general one and allows full flexibility. The others use specific scan pattern rules. As shown in FIG. 1A-1F, one picture can be divided into multiple slice groups. Each slice group in the picture is indicated by a line pattern and each slice group can be further divided into multiple slices in raster scan order, where each slice consists of non-overlapping macroblocks as the smallest coding unit. Each slice can be coded as an I-slice (intra-coded slice), P-slice (predictive slice) or B-slice (bi-directional slice) and the resulted data are packed into a slice-layer bitstream. Each slice can be parsed and reconstructed independently. However, the deblocking used by H.264/AVC standard is performed in an infinite impulse response (IIR) fashion and may be applied across slice boundaries. Therefore macroblocks of the entire picture are still deblocked in the raster scan order regardless of the FMO map types. Slice group types 0 through 5 are further explained as follows.

Type 0 as shown in FIG. 1A uses run lengths which are applied consecutively until the map is complete, where the picture consists of 14 macroblocks in each row and 12 macroblocks in each column. There are a total of 5 slice groups as indicated by individual line patterns. Each slice group consists of consecutive macroblocks in the raster scan order and therefore only the run lengths for the slice groups are needed to communicate to the decoder side to recover the slice group structure. Type 1, also known as scattered slice type is shown in FIG. 1B and it uses a mathematical function, which is known to both the encoder and the decoder, to configure the macroblocks into slice groups. The type 1 example as shown in FIG. 1B illustrates that the picture is configured into two slice groups having macroblocks interleaved horizontally and vertically to form the checkerboard pattern. Consequently, each macroblock in one group is always surrounded by four macroblocks from the other slice group. This type of FMO is useful for error resilience since a missing or erred macroblock in one slice group can be estimated from the four surrounding macroblocks of the other slice group. Type 2, as shown in FIG. 1C is used to mark rectangular areas, so-called regions of interest (ROI). There are three slice groups shown in FIG. 1C: two rectangular slice groups corresponding to ROIs and one slice group for the remaining macroblocks. In this case the top-left coordinates and the bottom-right coordinates of the rectangles are transmitted. This type of FMO is useful where some regions of the picture are of more interests than others such as the head and shoulder regions of video conference scenes. Types 3-5 as shown in FIGS. 1D-1F respectively are dynamic types that let the slice groups grow and shrink over different pictures in a cyclic way. Only the growth rate, the direction and the position in the cycle have to be known. Type 3 in FIG. 1D illustrates a spiral scan pattern, type 4 in FIG. 1E illustrates a horizontal scan pattern, and type 5 in FIG. 1F illustrates a vertical scan pattern.

In the high efficiency video coding (HEVC) under development, the fixed-size macroblock of H.264/AVC is replaced by a flexible block, named coding unit. FIG. 2 illustrates an exemplary coding unit partition based on a quadtree. At depth=0, the initial coding unit CU0, 212 consisting of 64×64 pixel, is the largest CU. The initial coding unit CU0, 212 is subject to quadtree split as shown in block 210. A split flag 0 indicates the underlying CU is not split and, on the other hand a split flag 1 indicates the underlying CU is split into four smaller coding units CU1, 222 by the quadtree. The resulting four coding units are labeled as 0, 1, 2 and 3 and each resulting coding unit becomes a coding unit for further split in the next depth. The coding units resulted from coding unit CU0, 212 are referred to as CU1, 222. After a coding unit is split by the quadtree, the resulting coding units are subject to further quadtree split unless the coding unit reaches a pre-specified smallest CU (SCU) size. Consequently, at depth 1, the coding unit CU1, 222 is subject to quadtree split as shown in block 220. Again, a split flag 0 indicates the underlying CU is not split and, on the other hand a split flag 1 indicates the underlying CU is split into four smaller coding units CU2, 232 by the quadtree. The coding unit CU2, 232, has a size of 16×16 and the process of the quadtree splitting as shown in block 230 can continue until a pre-specified smallest coding unit is reached. For example, if the smallest coding unit is chosen to be 8×8, the coding unit CU3, 242 at depth 3 will not be subject to further split as shown in block 240. The collection of quadtree partitions of a picture to form variable-size coding units constitutes a partition map for the encoder to process the input image area accordingly. The partition map has to be conveyed to the decoder so that the decoding process can be performed accordingly.

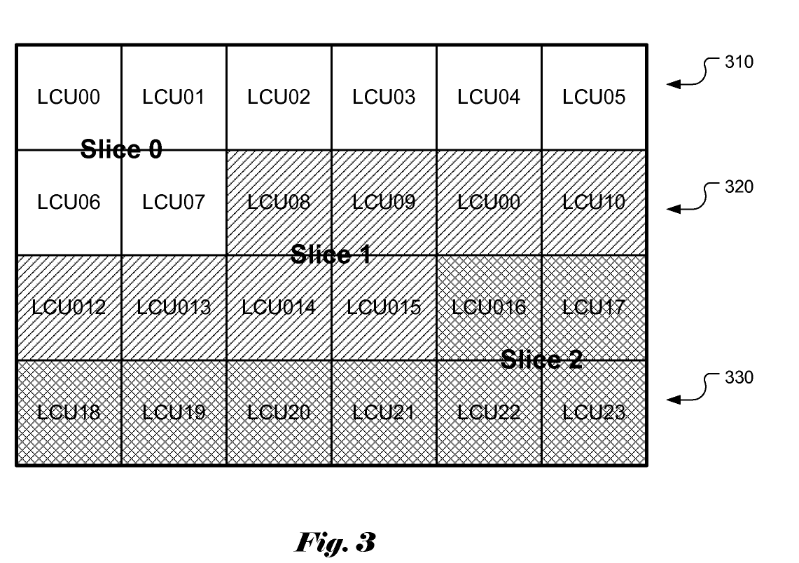

In the high efficiency video coding (HEVC) coding standard being developed, the largest coding unit (LCU) is used as an initial coding unit. The LCU may be adaptively divided into smaller CUs for more efficient processing. The macroblock-based slice partition for H.264can be extended to the LCU-based slice partition for HEVC. An example of the LCU-based slice partition for HEVC is shown in FIG. 3 where twenty-four LCUs are partitioned into three slices. LCU00 though LCU07 are assigned to slice 0, 310, LCU08 though LCU15 are assigned to slice 1, 320, and LCU16 though LCU23 are assigned to slice 2, 330. As shown in FIG. 3, the slice boundary is aligned with the LCU boundary. While the LCU-aligned slice partition is easy to implement, the size of LCU is much larger than the size of macroblock and the LCU-aligned slice may not be able provide enough granularities to support dynamic environment of coding systems. Therefore, a non-LCU aligned slice partition is being proposed in the HEVC standard development.

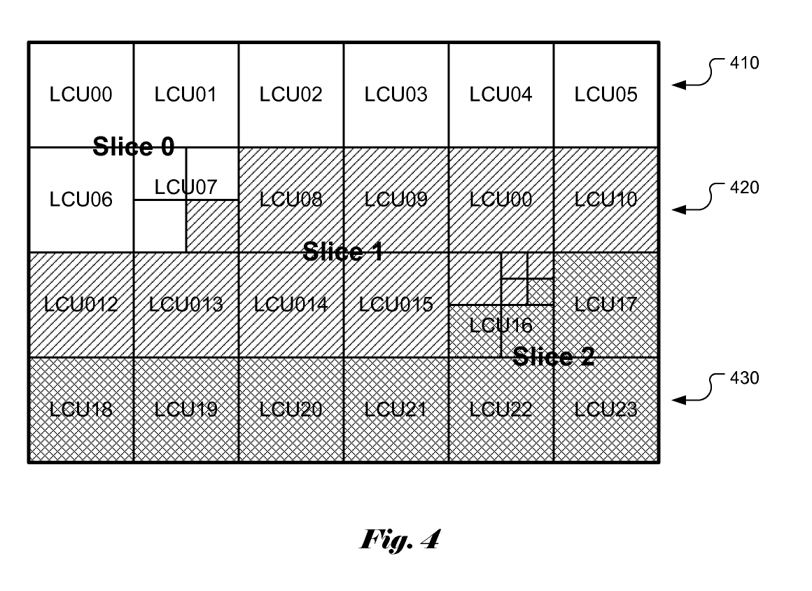

FIG. 4 illustrates an example of slice structure with the fractional LCU partition, where the partition boundaries may run through the largest coding units. Slice 0, 410 includes LCU00 through LCU06 and terminates at a leaf CU of LCU07. LCU07 is split between slice 0, 410 and slice 1, 420. Slice 1, 420 includes the remaining leaf CUs of LCU07 not included in slice 0, 410 and LCU08 through LCU15, and part of LCU16. Slice 1, 420 terminates at a leaf CU of LCU16. LCU16 is split between slice 1, 420 and slice 2, 430. Slice 2, 430 includes the remaining leaf CUs of LCU16 not included in slice 1, 420 and LCU17 through LCU23.

Currently, there is no slice or slice groups structure in the HEVC. It is very desirable to develop slice group structure for HEVC to provide similar advantage as the slice groups in H.264/AVC standard. Accordingly, slice group structure is disclosed herein for HEVC where slice group boundaries are always aligned with LCU boundaries while slice boundaries may be aligned or unaligned with LCU boundaries. Each slice group is divided into multiple slices in the raster scan order.

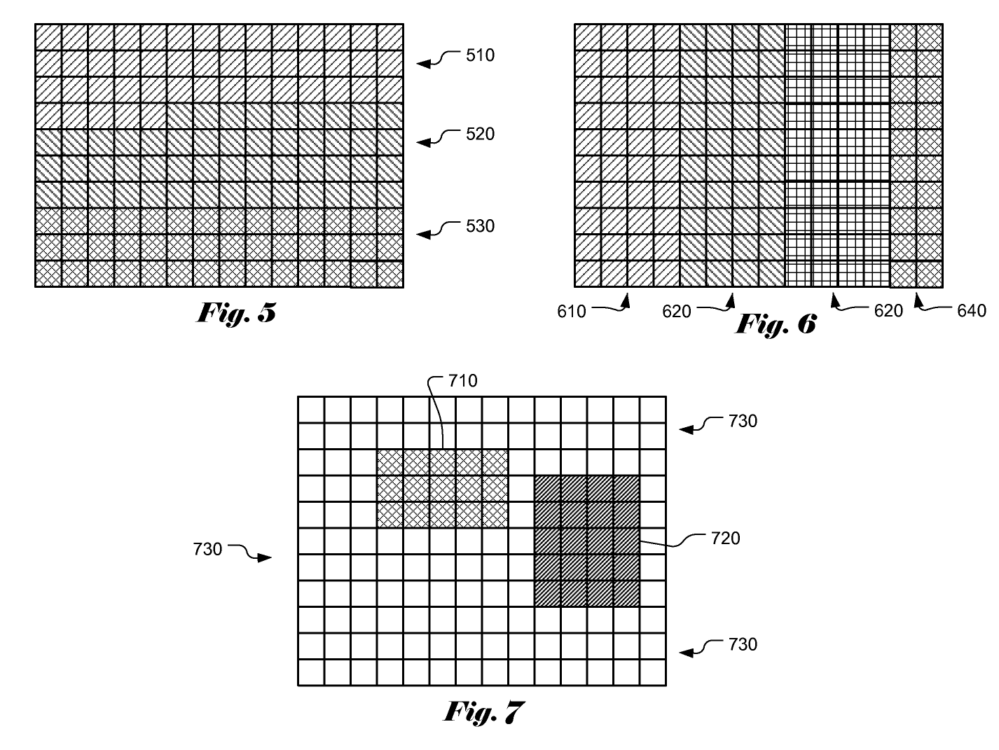

In type 0 for HEVC, as shown in FIG. 5, LCUs of a picture are partitioned into slice groups according to the raster scan order, where each slice group contains a number of LCUs in raster scan. The proposed type 0 is also known as the raster scan type. The number N of slice groups is first transmitted to the decoder side. Next, the number of LCUs is transmitted for every slice group except for the last slice group because the number of LCUs in the last slice group can be derived at the decoder side based on the total number of LCUs in the picture and the numbers of LCUs in the previous (N−1) slice groups. The picture consists of 140 LCUs and the picture is partitioned into 3 slice groups as indicated by different line patterns. Slice group 0, 510 consists of 47 LCUs, slice group 1, 520 consists of 47 LCUs, and slice group 2, 530 consists of 46 LCUs. The type 0 slice group for HEVC is similar to the type 0 slice group in the H.264/AVC standard; however different syntax elements may be used.

In type 1 for HEVC, as shown in FIG. 6, LCUs of a picture is sliced in the vertical direction into slice groups. Each slice group contains the same number of LCU columns except for the last slice group where the last slice group may have fewer LCU columns. The number of slice groups, NumSG, is transmitted to the decoder side, and the number of LCU columns per slice group except for the last slice group can be calculated by dividing (NumPicLcuCol+NumSG−1) by NumSG and truncating the fractional part, where NumPicLcuCol denotes the number of LCU columns per picture. The proposed type 1 is also called the vertical stripe type. As illustrated in FIG. 6, the picture has 14 LCU columns divided into 4 slice groups as indicated by different line patterns. Slice group 0, 610 consists of four LCU columns, slice group 1, 620 consists of four LCU columns, slice group 2, 630 consists of four LCU columns, and slice group 3, 640 consists of two LCU columns. In video encoding or decoding hardware implementation, on-chip line (row) buffers are needed to store coding unit modes, search area pixels, reference indices, motion vectors, reconstructed pixels, intra prediction modes and etc. for motion estimation, motion compensation, intra prediction, fast mode decision, deblocking, and CABAC context formation. The buffer size is proportional to the slice group width, which is the same as the picture width for conventional video coding standards. However, according to the slice group structure as disclosed in FIG. 6, the video data is processed as individual slice groups and each slice group has 4 LCUs or less in each row. Therefore, only 4 previous LCUs need to be buffered when the current row of LCUs are being processed. Consequently, the type 1 slice group structure as disclosed in FIG. 6 results in a much smaller slice width, which can significantly reduce the line buffers for hardware implementations. In addition, the type 1 slice group structure as disclosed in FIG. 6 can be used for parallel encoding and parallel decoding. The type 1 slice group structure for HEVC as shown in FIG. 6 is totally different from the type 1 slice group structure in the H.264/AVC standard.

Type 2 for HEVC as shown in FIG. 7 is similar to the type 2 slice group of the H.264/AVC standard and is mainly designed for regions of interest. Each slice group is a rectangular region except that the last slice group contains all remaining LCUs. The number of slice groups and slice group coordinates including the top-left coordinate, the width and height of each rectangular region are transmitted to the decoder side. Slice group 0, 710 and slice group 1, 720 are two rectangular regions and can be regarded as two “regions-of-interest” slice groups, while the remaining LCUs belong to the slice group 2, 730. The type 2 slice group structure for HEVC is similar to the type 2 slice group structure of the H.264/AVC standard, however the syntax elements are somewhat different. The proposed type 2 is also called the ROI type.

Type 3 for HEVC is similar to the type 6 slice group for the H.264/AVC standard and is mainly designed for full flexibility. Each slice group can be assigned any LCU of the picture. The number of slice groups is transmitted to the decoder side. A slice group ID is transmitted for each LCU.

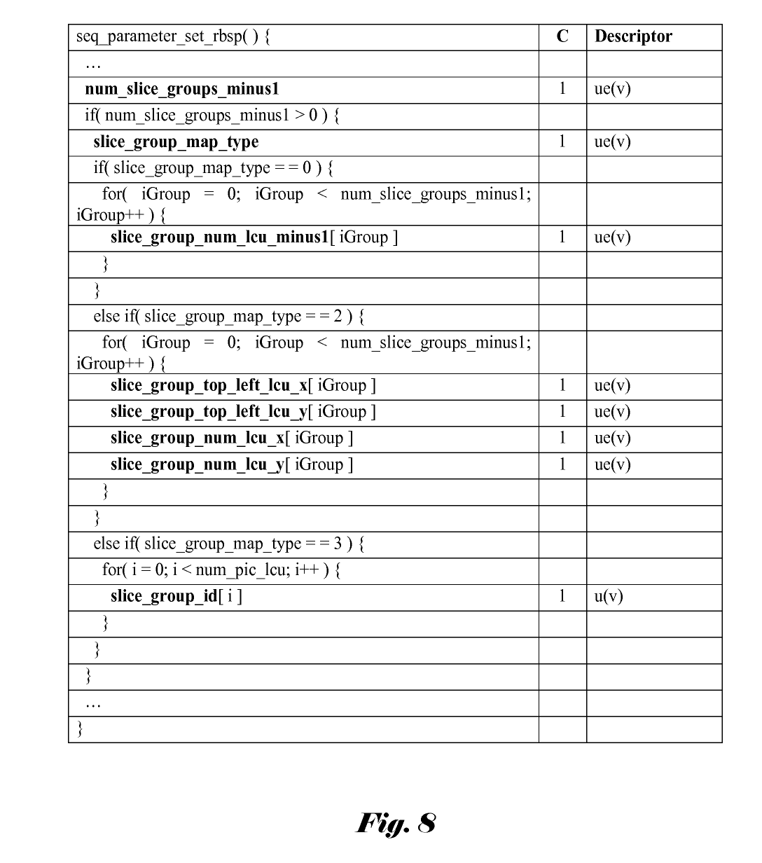

In order to communicate the information required for a decoder to recover the slice group structure selected by the encoder, a set of syntax elements is developed as shown in FIG. 8. In the exemplary syntax design as shown in FIG. 8, the required slice group information is incorporated in the sequence header, i.e., the SPS header. Nevertheless, the required information may also be incorporated in the picture header, i.e., PPS header. The syntax element num_slice_groups_minus1 refers to the number of slice groups for a picture minus 1. For the case of num_slice_groups_minus1>1, it implies that there are more than one slice group in each picture and accordingly the syntax element slice_group_map_type is incorporated to indicate the type of slice groups selected. According to the slice_group_map_type value (0, 1, 2 or 3), an individual routine is executed. For type 0, i.e., slice_group_map_type=0, the routine incorporates the number of LCUs minus 1, slice_group_num_lcu_minus1[iGroup] for the iGroup-th slice group. As mentioned before, each of the type 0 slice groups consists of consecutive LCUs in the raster scan order. The slice group structure can be recovered if the number of LCUs for each slice group is known. Also as mentioned before, the number of LCUs in the slice group is needed only for (N-1) slice groups. Consequently, the loop termination is tested for iGroup<num_slice_groups_minus1. For type 2, i.e., slice_group_map_type=2, the routine incorporates the coordinates of top left corner, slice_group_top_left_lcu_x[iGroup] and slice_group_topleft_lcu_y[iGroup], the width, slice_group_num_lcu_x[iGroup] and the height, slice_group_num_lcu_y[iGroup] of the slice group iGroup. For type 3, i.e., slice_group_map_type=3, the routine assigns a slice group ID, slice_group_id[i] for the i-th LCU in the picture. The size of the slice_group_id[i] syntax element is the minimum number of bits to represent the (num_slice_groups_minus1+1) integers. The value of slice_group_id[i] should be in the range from 0 to num_slice_groups_minus1, inclusive. The index i can be in the range from 0 to num_pic_lcu, where num_pic_lcu denotes the number of LCUs of the current picture and can be derived on the decoder side. For type 1, the number of slice groups, NumSG, is needed for the decoder to recover the slice group structure. However, the number of slice groups minus 1, num_slice_groups_minus1 is already transmitted in the sequence header as shown in FIG. 8. The number of slice groups, NumSG, can be easily derived from NumSG=num_slice_groups_minus1+1. As mentioned previously, the number of LCU columns per slice group except for the last slice group can be calculated by dividing (NumPicLcuCol+NumSG−1) by NumSG and truncating the fractional part. NumPicLcuCol denotes the number of LCU columns per picture and can be derived from the picture width and the LCU size. The information related to the picture width and the LCU size should already be transmitted in sequence header or picture header. Therefore, there is no additional information needed to transmit for type 1. Accordingly, there is no routine corresponding to type 1 as shown in FIG. 8.

According to the above description, a slice group structure and associated syntax for HEVC are disclosed. Each slice group can be further divided into multiple slices in raster scan order and each slice consists of one or more LCUs. The slice group is always LCU aligned. However, the slice may be LCU aligned or non-LCU aligned. Four types of slice groups are disclosed for HEVC corresponding to consecutive raster scan, uniform vertical slicing (except for the last slice group), regions of interest, and full flexibility respectively. The consecutive raster scan type, i.e., type 0, communicates (N-1) numbers of LCUs for N slice groups since the number of LCUs for the last slice group can be derived from the total number of LCUs for the picture and the (N-1) numbers of LCUs for the first (N-1) slice groups. The vertically sliced slice group structure, i.e., type 1, provides the advantage of reduced line (row) buffers. The regions of interest structure, i.e., type 2, communicates the top left coordinates and the width and height, instead of coordinates of the bottom-right corner of a rectangular region for potential information reduction. The syntax elements required to communicate the slice group structure between an encoder and a decoder are disclosed and an example of incorporating the slice group information in the SPS header is illustrated. While the example for SPS header is illustrated, the slice group information may also be incorporated in the picture header. In some embodiments, the slice group is adaptive at picture level by sending slice group parameters in an additional picture layer raw byte sequence payload (RBSP).

A total of 4 slice group types are disclosed above. Nevertheless, more slice group types can be added. Furthermore, not all slice group types have to be used in a system. Instead, a system may use any single slice group type or a combination of multiple slice group types as needed. For example, a video conference system according to the present invention may select to incorporate the type 1 and type 2 to form slice groups. When the system is used in a heavy traffic network, the ROI type, i.e., type 2 can be used for quality consideration where the ROIs corresponding to head and should portion can be always transmitted with higher priority. When the system is used in a high-definition environment, the system may use type 1 to reduce the line buffer requirement. A decoder embodying the present invention can extract information about the number of slice groups, i.e., num_slice_groups_minus1 and the slice group type, i.e., slice_group_maptype from the sequence or picture header. According to slice_group_map_type, the decoder will extract further information regarding the slice group structure as needed. With the information about slice group structure know, the decoder may use a processor to reconstruct a set of member LCUs and configure the set of member LCUs to recover slice groups according to the information about slice group structure. The processor may be in various forms of hardware, software/firmware/machine codes executable on a CPU/DSP, or a combination of both.

The invention may be embodied in other specific forms without departing from its spirit or essential characteristics. The invention may be embodied in hardware such as integrated circuits (IC) and application specific IC (ASIC), software and firmware codes associated with a processor implementing certain functions and tasks of the present invention, or a combination of hardware and software/firmware. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for coding of video pictures, wherein each of the video pictures is divided into a plurality of LCUs (largest coding units), the method comprising:
partitioning each of the video pictures into two or more slice groups according to a slice group type, wherein each of said two or more slice groups comprises one or more member LCUs of the plurality of LCUs and said wherein said each of said two or more slice groups is divided into one or more slices;
processing said each of said two or more slice groups to provide a bitstream corresponding to said each of said two or more slice groups, wherein the bitstream can be used to recover said each of said two or more slice groups independently; and
incorporating slice group information associated with said two or more slice groups in the bitstream.

2. The method of claim 1, wherein said one or more slices are LCU aligned.

3. The method of claim 1, wherein said one or more slices are non-LCU aligned.

4. The method of claim 1, wherein the slice group information comprises one or more syntax elements in a sequence header or a picture header to convey information associated with said two or more slice groups.

5. The method of claim 4, wherein said one or more syntax elements comprises a number of said two or more slice groups and the slice group type.

6. The method of claim 1, wherein the slice group type includes a vertical-stripe type wherein said each of said two or more slice groups consists of one or more consecutive vertical LCU columns.

7. The method of claim 6, wherein said each of said two or more slice groups except for a last one of said two or more slice groups contains a fixed number of said one or more consecutive vertical LCU columns and the last one of said two or more slice groups contains less than or equal to the fixed number of said one or more consecutive vertical LCU columns.

8. The method of claim 1, wherein the slice group type includes a raster scan type, wherein said two or more slice groups are formed by slicing the plurality of LCUs in a raster scan order.

9. The method of claim 8, wherein the slice group information comprises one or more syntax elements in a sequence header or a picture header, and said one or more syntax elements comprises information associated with a first number of said two or more slice groups and a second number of said one or more member LCUs for said each of said two or more slice groups except for a last one of said two or more slice groups.

10. The method of claim 1, wherein the slice group type includes an ROI (regions of interest) type, wherein said each of said two or more slice groups except for a last one of said two or more slice groups is in a rectangular shape having a width of a first number of LCUs and height of a second number of LCUs, and the last one of said two or more slice groups consists of remains LCUs of the plurality of LCUs.

11. The method of claim 10, wherein the slice group information comprises one or more syntax elements in a sequence header or a picture header, and said one or more syntax elements comprises information associated with coordinates of an upper-left corner, the first number and the second number for said each of said two or more slice groups.

12. An apparatus for coding of video pictures, wherein said each of the video pictures is divided into a plurality of LCUs (largest coding units), the apparatus comprising:
means for partitioning each of the video pictures into two or more slice groups according to a slice group type, wherein said each of said two or more slice groups comprises one or more member LCUs of the plurality of LCUs and said each of said two or more slice groups is divided into one or more slices; and
means for processing said each of said two or more slice groups to provide a bitstream corresponding to said each of said two or more slice groups, wherein the bitstream can be used to recover said each of said two or more slice groups independently.

13. The apparatus of claim 12, wherein said one or more slices are LCU aligned.

14. The apparatus of claim 12, wherein said one or more slices are non-LCU aligned.

15. The apparatus of claim 12, further comprising means for incorporating one or more syntax elements in a sequence header or a picture header to convey information associated with said two or more slice groups.

16. The apparatus of claim 15, wherein said one or more syntax elements comprises information associated with a number of said two or more slice groups and the slice group type.

17. The apparatus of claim 12, wherein the slice group type includes a vertical-stripe type wherein said each of said two or more slice groups consists of one or more consecutive vertical LCU columns.

18. The apparatus of claim 17, wherein said each of said two or more slice groups except for a last one of said two or more slice groups contains a fixed number of said one or more consecutive vertical LCU columns and the last one of said two or more slice groups contains less than or equal to the fixed number of said one or more consecutive vertical LCU columns.

19. The apparatus of claim 12, wherein the slice group type includes a raster scan type, wherein said two or more slice groups are formed by slicing the plurality of LCUs in a raster scan order.

20. The apparatus of claim 19, further comprising means for incorporating one or more syntax elements in a sequence header or a picture header to convey information associated with said two or more slice groups, wherein said one or more syntax elements comprises information associated with a first number of said two or more slice groups and a second number of said one or more member LCUs for said each of said two or more slice groups except for a last one of said two or more slice groups and said second number is not incorporated for the last one of said two or more slice groups.

21. The apparatus of claim 12, wherein the slice group type includes an ROI (regions of interest) type, wherein said each of said two or more slice groups except for a last one of said two or more slice groups is in a rectangular shape having a width of a first number of LCUs and height of a second number of LCUs, and the last one of said two or more slice groups consists of remains LCUs of the plurality of LCUs.

22. The apparatus of claim 21, further comprising means for incorporating one or more syntax elements in a sequence header or a picture header to convey information associated with said two or more slice groups, wherein said one or more syntax elements comprises information associated with coordinates of an upper-left corner, the first number and the second number for said each of said two or more slice groups.

23. A method for decoding of a video bitstream corresponding to video pictures, wherein each of the video pictures is divided into a plurality of LCUs (largest coding units) and the plurality of LCUs are configured into two or more slice groups, the method comprising:
extracting a number of said two or more slice groups from a sequence header or a picture header of the video bitstream;
extracting a slice group type from the sequence header or the picture header of the video bitstream; and
recovering said two or more slice groups according to the slice group type.

24. The method of claim 23, if a vertical-stripe type is indicated by the slice group type, the method further comprising:
reconstructing a set of member LCUs corresponding to said each of said two or more slice groups from a portion of the video bitstream; and
configuring the set of member LCUs into one or more consecutive vertical LCU columns according to the number of said two or more slice groups, LCU size and video frame size.

25. The method of claim 23, if a raster scan type is indicated by the slice group type, the method further comprising:
extracting a set of LCU counts for said two or more slice groups except for a last one of said two or more slice groups from the sequence header or picture header;
deriving a last LCU count for said last one of said two or more slice groups based on the set of LCU counts and a total LCU count for one of the video pictures;
reconstructing a set of member LCUs corresponding to said each of said two or more slice groups from a portion of the video bitstream to form a set of reconstructed member LCUs; and
configuring the set of reconstructed member LCUs in raster scan order to form said each of said two or more slice groups based on the set of LCU counts and the last LCU count.

26. The method of claim 23, if an ROI type is indicated by the slice group type, the method further comprising:
extracting top-left coordinates, region width and region height for said each of said two or more slice groups from the sequence header or the picture header;
reconstructing a set of member LCUs corresponding to said each of said two or more slice groups from a portion of the video bitstream to form a set of reconstructed member LCUs; and
configuring the set of reconstructed member LCUs to form said each of said two or more slice groups based on the top-left coordinates, the region width and the region height.

27. An apparatus for decoding of a video bitstream corresponding to video pictures, wherein each of the video pictures is divided into a plurality of LCUs (largest coding units) and the plurality of LCUs are configured into two or more slice groups, the apparatus comprising:
means for extracting a number of said two or more slice groups from a sequence header or a picture header of the video bitstream;
means for extracting a slice group type from the sequence header or the picture header of the video bitstream; and
a processor is configured to recover said two or more slice groups according to the slice group type.

28. The apparatus of claim 27, wherein the processor is configured, if a vertical stripe type is indicated by the slice group type, to reconstruct a set of member LCUs corresponding to said each of said two or more slice groups from a portion of the video bitstream and to form the set of member LCUs into one or more consecutive vertical LCU columns according to the number of said two or more slice groups, LCU size and video frame size.

29. The apparatus of claim 27, wherein the processor is configured, if a raster scan type is indicated by the slice group type:
to extract a set of LCU counts for said two or more slice groups except for a last one of said two or more slice groups from the sequence header or picture header;
to derive a last LCU count for said last one of said two or more slice groups based on the set of LCU counts and a total LCU count for one of the video pictures;
to reconstruct a set of member LCUs corresponding to said each of said two or more slice groups from a portion of the video bitstream to form a set of reconstructed member LCUs; and
to form said each of said two or more slice groups based on the set of LCU counts and the last LCU count from the set of reconstructed member LCUs in raster scan order.

30. The apparatus of claim 27, wherein the processor is configured, if a ROI type is indicated by the slice group type:
to extract top-left coordinates, region width and region height for said each of said two or more slice groups from the sequence header or the picture header;
to reconstruct a set of member LCUs corresponding to said each of said two or more slice groups from a portion of the video bitstream to form a set of reconstructed member LCUs; and
to form said each of said two or more slice groups based on the top-left coordinates, the region width and the region height from the set of reconstructed member LCUs.
